(19) United States
(12) Patent Application Publication
(10) Pub. No.: US 2014/0068510 A1
(43) Pub. Date: Mar. 6, 2014

(54) MATRIX MENU

(71) Applicants: Kai Richter, Niebergallweg (DE); Vera Legisa, Klara-Siebert-Strasse (DE); Jan Kurpjoweit, Bruehl (DE)

(72) Inventors: Kai Richter, Niebergallweg (DE); Vera Legisa, Klara-Siebert-Strasse (DE); Jan Kurpjoweit, Bruehl (DE)

(73) Assignee: SAP AG, Walldorf (DE)

(21) Appl. No.: 13/603,708

(22) Filed: Sep. 5, 2012

(51) Int. Cl. G06F 3/048

(52) U.S. Cl. 715/810

(57) ABSTRACT

The present disclosure describes methods, systems, and computer program products for generating matrix menus. One computer-program product includes computer-readable instructions embodied on tangible non-transitory media and configured when executed to generate an array of a number of navigation items arranged into a number of columns and rows. In response to a selection of one of the number of navigating items, a navigation list operable to launch at least one application associated with the navigation list is generated. In response to a selection of one of the application associated with the navigation list, the application can be executed.

### BACKGROUND

A menu is a list of options or commands presented to a user by a computer or communications system on a display. A menu is used in contrast to a command-line interface (CLI), where instructions to the computer are given in the form of a string of commands, verbs, and/or operators. Choices presented on a menu may be selected by the operator using a number of methods or interfaces, for example, by depressing one or more keys on a keyboard or mouse, by positioning a cursor using a keyboard, mouse, or directional-pad, by using an electro-mechanical input device (e.g., a light pen), by touching the display with a finger, or by speaking to a voice-recognition system.

In some situations, computers using a graphical user interface (GUI) present menus with a combination of text and/or symbols to represent choices. By selecting text and/or symbols, the user selects an instruction that the text and/or symbols represent. A context menu is a menu in which the choices presented to the user are determined according to a current context in which the user is working, for example, presenting possible operations available when a specific file type is selected.

A common use of menus is to provide convenient access to various operations such as saving or opening a file, quitting a program, or manipulating data. Most widget toolkits provide some form of pull-down or pop-up menu. Pull-down menus commonly used to provide action operations in menu bars usually presented near the top of a GUI window or screen, whereas pop-up (or “fly-out”) menus are commonly used for setting a value, and might appear anywhere in the GUI window or screen.

Menus are sometimes hierarchically organized, allowing navigation through different levels of a menu structure. Selecting a menu item may result in an expanded menu, for example a sub-menu, where the sub-menu contains options related to the selected menu item.

### SUMMARY

The present disclosure relates to methods, systems, and computer-readable media for generating matrix menus. One computer-program product includes computer-readable instructions embodied on tangible non-transitory media and configured when executed to generate an array of a number of navigation items arranged into a number of columns and rows. In response to a selection of one of the number of navigating items, a navigation list operable to launch at least one application associated with the navigation list is generated. In response to a selection of one of the application associated with the navigation list, the application can be executed.

In some specific aspects, the computer-program product can include additional features. For example, the at least one application associated with the navigation list can be defined by a user, and/or an installation application. The at least one application can be an executable file, a software program, a data file, a business application, or a web application. And at least one application is associated with at least one of the array of navigation items. The array of navigation items can include one menu navigation column and a plurality of menu navigation rows. The array of navigation items can further include a number of navigation layers, and/or a number of menu navigation columns and menu navigation rows. Each navigation items is capable of displaying a graphical notification. The array of navigation items can include non-text graphical icons, and/or a number of matrices.

Other implementations of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The subject matter described in this specification can be implemented in particular implementations so as to realize one or more of the following advantages. The matrix menus can provide to a user a succinct, well-organized, and efficient way to access functions and information. For example, the matrix menus can be arranged as a multi-dimensional icon array where each icon is a navigation item operable to expand into one or more navigation lists, applications, and/or files. The navigation lists can be customized by the user and connected to various applications and files. In some implementations, changes or updates associated with the various applications and files can be directly displayed in both the navigation lists as well as the multi-dimensional icon array. The multi-dimensional icon array can also uniquely represent the application or system environment being operated upon, acting as a recognizable icon itself.

While generally described as computer-implemented software embodied on tangible and non-transitory media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example environment for implementing various features of a system using matrix menus.

FIGS. 2A and 2B illustrate example matrix menus.

FIGS. 3A and 3B illustrate example functions of matrix menus.

FIG. 4 illustrates an example method for generating matrix menus.

### DETAILED DESCRIPTION

This specification describes methods, systems, and computer-readable media for generating matrix menus. The matrix menus can provide to a user a succinct, well-organized, and efficient way to access functions and information. For example, the matrix menus can be arranged as a multi-dimensional icon array where each icon is a navigation item operable to expand into one or more navigation lists, applications, and/or files. The navigation lists can be customized by the user and connected to various applications and/or files. In some implementations, changes or updates associated with the various applications and files can be directly displayed in both the navigation lists as well as the multi-dimensional icon array. The multidimensional icon array can also uniquely represent the application or system environment being operated upon, acting as a recognizable icon itself.

The multi-dimensional array can be uniquely associated with a particular application or system environment. In general, the multi-dimensional array may be one, two, or three dimensional. For example, the array can be a single-dimensional row or column of icons, presenting a less intrusive view in the user interface. The array can also be a two-dimensional array of icons, for example a square or rectangle shape, enabling a concentrated area of command. The array may also be a three-dimensional array, for example a cube or other similar shape, providing improved ease of interaction. In some implementations, the navigation items can display text, pictogram, symbols, colors, indicators, and/or other suitable representations of navigation items. In this specification, the navigation items are associated with a navigation list, which includes links to various applications and/or data. Users may select one of the navigation items from the array and expand the navigation list to further select a desired link to access data or execute applications.

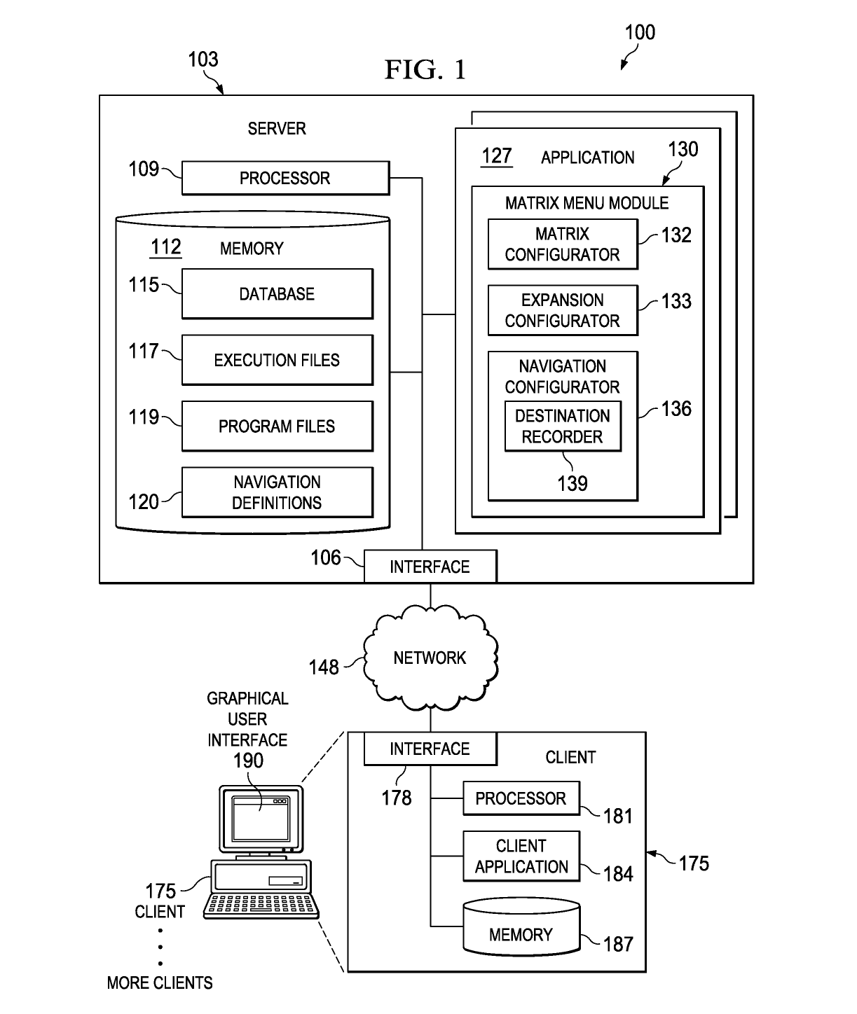

FIG. 1 illustrates an example environment 100 for implementing various features of a system for generating matrix menus. The illustrated example environment 100 includes, or is communicably coupled with, a client 175, and a server 103. At least some of the communications between the server 103 and the client 175 may be performed across or using network 148. In general, environment 100 depicts an example configuration of a system for receiving messages from the client 175 at the server 103. For example, the server 103 can provide applications, processing resources, and/or database to the client 175 (e.g., to support client applications 184). In alternative implementations, the elements illustrated in FIG. 1 can be included in or associated with different and/or additional servers, clients, networks, and locations other than those as shown. For example, there may be additional clients sending messages to the server 103. As another example, multiple clients may be connected to one or more servers similar to the server 103 to obtain various functionalities and services. In some implementations, one or more of the components illustrated within the server 103, the client 175, or any of the other illustrated components, can be located in multiple or different servers, cloud-based networks, or other locations accessible to the server 103 (e.g., either directly or indirectly using network 148).

At a high level, the server 103 can be connected with one or more clients such as the client 175. For example, the server 103 can host an application 127 that can be accessed by the one or more clients 175 using requests to server 103. The server 103 may also provide background support (e.g., license, updates, computation, storage, etc.) to the client application 184. In some implementations, the application 127 can include a matrix menu module 130 for generating and implementing matrix menus; in other implementations, the client application 184 can include its own, similar matrix menu module. In some implementations, the client application 184 can be a web application, for example a web browser, running the application 127.

In the illustrated implementation of FIG. 1, the server 103 includes an interface 106, a processor 109, memory 112, and the application 127.

The interface 106 is used by the server 103 to communicate with other systems in a client-server or other distributed environment (including within environment 100) connected to the network 148 (e.g., the client 175, as well as other systems communicably coupled to the network 148). The interface 106 generally includes logic encoded in software and/or hardware in a suitable combination and operable to communicate with the network 148. More specifically, the interface 106 may include software supporting one or more communication protocols associated with communications such that the network 148 or the interface hardware is operable to communicate physical signals within and outside of the illustrated environment 100.

The processor 109 can be any appropriate processing unit or units to enable computation in the server 103. Although illustrated as a single processor 109 in the server 103, two or more processors may be used in the server 103 according to particular needs, desires, or particular embodiments of environment 100. Generally, the processor 109 executes instructions and manipulates data to perform the operations of the server 103 and, specifically, the functionality associated with the corresponding application 127. In one implementation, the server's processor 109 executes the functionality required to receive inbound communications from and send outbound communications to the client 175, as well as the functionality required to perform the operations of the associated application 127, among others.

The memory 112 of the illustrated server 103 stores at least a database 115 or other storage for execution files 117, program files 119, navigation definitions 120, and other data and program instructions. In some implementations, including a cloud-based system, some or all of the memory 112 may be stored remote from the server 103, and communicably coupled to the server 103 for usage. Specifically, memory 112 can store execution files 117, program files 119, and navigation definitions 120. The execution files 117 can be associated with applications and opened to execute certain functions defined in the applications. The program files 119 can include data files used in programs during or after launching of an application. The navigation definitions 120 include definitions of links in the navigation lists of the matrix menus, where the definitions can be personalized by users. Some or all of the elements illustrated within memory 112 may be stored external to the memory 112.

At a high level, the application 127 can be any application, program, module, process, or other software that may execute, change, delete, generate, or otherwise manage information associated with a particular server 103. In particular, the application 127 may be associated with one or more business processes that communicate with other users, applications, systems, and components to send, receive, and process events. In some implementations, a particular application 127 may operate in response to and in connection with one or more requests received from an associated client 175 or other remote client. Additionally, a particular application 127 may operate in response to and/or in connection with one or more requests received from other applications external to the server 103. In some implementations, the application 127 may request additional processing or information from an external system or application. In some implementations, one or more of the applications may represent a web-based application accessed and executed by remote clients 175 using the network 148 (e.g., through the Internet, or using one or more cloud-based services associated with the application 127). Further, while illustrated as internal to the server 103, one or more processes associated with a particular application 127 may be stored, referenced, or executed remotely. For example, a portion of a particular application 127 may be a web service that is remotely called, while another portion of the application 127 may be an interface object or agent bundled for processing at a remote system (not illustrated), or a particular client 175 (e.g., the client application 184). Moreover, any or all of a particular application 127 may be a child or sub-module of another software module or enterprise application (not illustrated) without departing from the scope of this disclosure. Still further, portions of the particular application 127 may be executed or accessed by a user working directly at the server 103, as well as remotely at a corresponding client 175.

The application 127 includes a matrix menu module 130 that enables the application 127 to generate matrix menus for interacting with users. The matrix menus can be displayed at launch or at any time during operation of the application 127. The matrix menu module 130 includes at least a matrix configurator 132, an expansion configurator 133, and a navigation configurator 136. In general, users can define the appearance of the matrix menus by using the matrix configurator 132. Users can customize navigation lists associated with the matrix menus using the expansion configurator 133 and define the functions and information associated with the navigation lists using the navigation configurator 136. For example, the matrix configurator 132 enables users to define features of the matrix menus, such as the number of dimensions, the number of navigation items, types of navigation items, among others. The expansion configurator 133 enables users to define the relationship or connection between each navigation item and the navigation list. The navigation configurator 136 enables users to define actions taken in response to selection in the navigation lists; for example, the actions including launching an application, opening data files, responding to updates or changes, among others. In some implementations, the matrix configurator 132, the expansion configurator 133, and/or the navigation configuration 136 presents a graphical user interface (GUI) to allow the user to perform operations associated with the respective associated component. In some implementations, user definitions and/or configurations can be performed by installation agents or programs. For example, an application may intrinsically contain a default matrix menu that is installed, launched, and/or configured with the application.

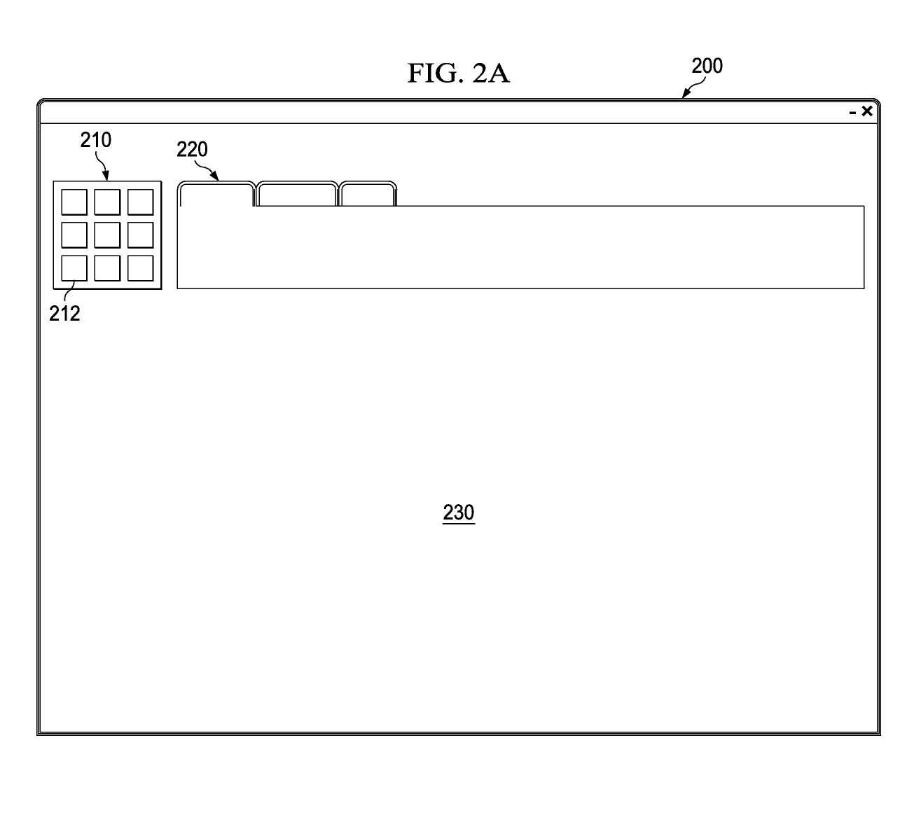

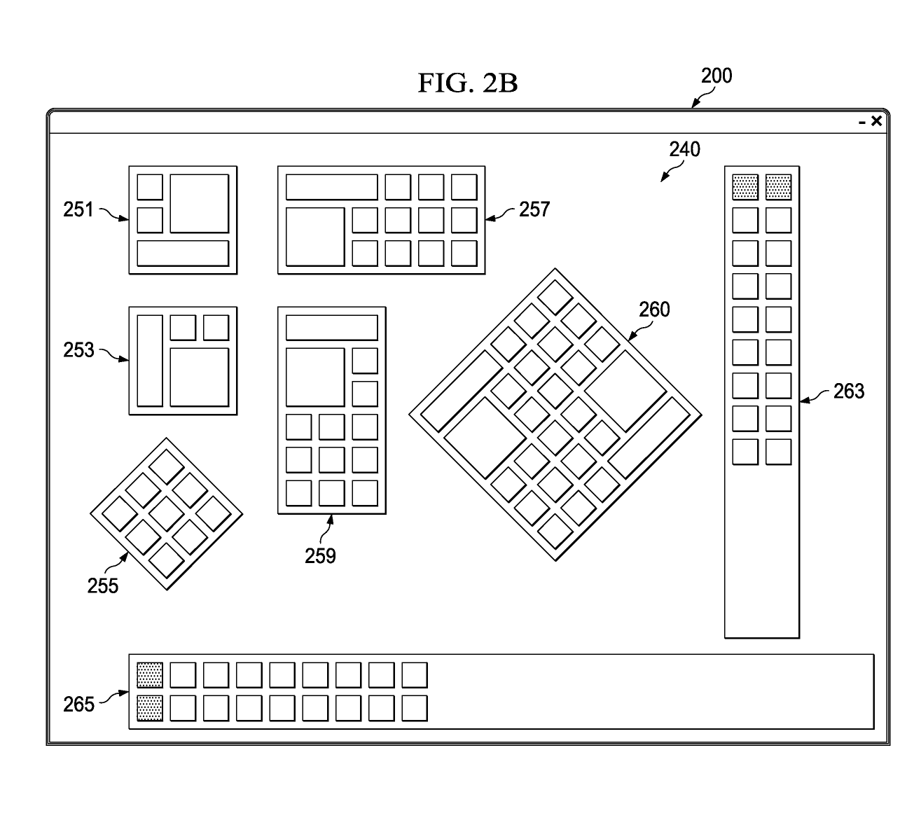

The matrix configurator 132 enables users to define features of the matrix menus. For example, a two-dimensional matrix menu may include a number of navigation item columns and rows. A three-by-three array of navigation items includes three columns and three rows of navigation items. The navigation items can display icons, pictograms, texts, animations, and other suitable content. In other implementations, the matrix menu can be, for example, three-by-two, two-by-two, two-by-three, four-by-five, or any suitable set of dimensions. In some implementations, the navigation items can be of different dimensions and arranged in an irregular manner. One purpose of allowing different dimensional settings and/or irregular configurations is to permit a user to distinguish between different matrix menus and to allow a unique overall appearance for recognition purposes. More example layouts and configurations are illustrated in FIG. 2B. These examples are for illustrative purposes only and should not be seen as limiting on possible configurations of matrix menus.

The expansion configurator 133 enables users to define a navigation list of programs, files, links, or other contents to be associated with each navigation item in the matrix menus. When a user selects the navigation item in the matrix menu, for example by using a cursor or a touch on a touch-screen, the navigation list can be expanded from the matrix menu. The user can then further select the particular programs, applications, or files from the presented expanded navigation list. In some implementations, the expansion configurator 133 enables users to define the navigation items as a direct link to applications, files, or other resources without expanding the navigation list.

The navigation configurator 136 enables users to customize and define each item on a navigation list. For example, a navigation list related to business transactions can further include items for sales, customers, orders, factories, and other related information. Users can order, prioritize, and group the items based on preference. The navigation configurator 136 can include a destination recorder 139, recording the destination commands or files associated with the items on the navigation list. The recorded information can then be stored in the navigation definitions 120 in the memory 112.

In general, the server 103 is any server or system that stores, manages, and executes functionality associated with the application 127. Additionally, the server 103 may execute one or more applications 127. In some instances, each server 103 may store a plurality of various applications; while in other instances, the server 103 may be a dedicated server meant to store and execute the application 127 for a particular platform or application and its related functionality. In some instances, the server 103 may include a web server or be communicably coupled with a web server, where one or more of the applications 127 associated with the server 103 represent web-based (or web-accessible) applications accessed and executed through requests and interactions received by the client 175, executing a client application 184 operable to interact with programmed tasks or one or more applications 127.

The server 103 can include an electronic computing device operable to receive, transmit, process, store, or manage data and information associated with the environment 100. The server 103 illustrated in FIG. 1 can be responsible for receiving application-related requests from one or more clients 175 (as well as any other entity or system interacting with the server 103, including desktop or mobile client systems), responding to the received requests by processing said requests in the associated application 127, and sending the appropriate responses from the appropriate component back to the requesting client 175 or other requesting system. Components of the server 103 can also process and respond to local requests from a user locally accessing the server 103. Accordingly, in addition to requests from the client 175 illustrated in FIG. 1, requests associated with a particular component may also be sent from internal users, external or third-party customers, and other associated business applications, business processes, as well as other appropriate entities, individuals, systems, or computers. In some instances, the application 127 or the client application 184 may be a web-based application executing functionality associated with a networked or cloud-based business process.

Referring now to the client 175 illustrated in FIG. 1, the client 175 may be any computing device operable to connect to or communicate with the server 103 using a wireline or wireless connection directly or using the network 148, or another suitable communication means or channel. In some instances, the client 175 may be a part of or associated with a business process involving one or more of a remote developer or user associated with the application 127, for example, the client application 184. It will be understood that there may be any number of clients 175 associated with, or external to, environment 100. For example, while illustrated environment 100 includes a single client 175, alternative implementations of environment 100 may include multiple sellers or customers communicably coupled to one or more of the systems illustrated. In some instances, one or more clients 175 may be associated with administrators of the environment, and may be capable of accessing and interacting with the settings and operations of one or more applications 127, and/or other components of the illustrated environment 100. Additionally, there may also be one or more additional clients 175 external to the illustrated portion of environment 100 capable of interacting with the environment 100 using the network 148.

The illustrated client 175 further includes an interface 178, a processor 181, and a memory 148. The interface 178 is used by the client 175 for communicating with other systems in a distributed environment—including within the example environment 100—connected to the network 148; for example, the server 103 as well as other systems communicably coupled to the network 148 (not illustrated). The interface 178 may also be consistent with the above-described interface 106 of the server 103 or other interfaces within the example environment 100. The processor 181 may be consistent with the above-described processor 109 of the server 103 or other processors within the example environment 100. Specifically, the processor 181 executes instructions and manipulates data to perform the operations of the client 175, including the functionality required to send requests to the server 103 and to receive and process responses from the server 103. The memory 187 may be consistent with the above-described memory 112 of the server 103 or other memories within the example environment 100 but storing objects and/or data associated with the purposes of the client 175.

Further, the representative client 175 illustrates a GUI 190 applicable to the client 175 in general. The GUI 190 provides a visual interface with at least a portion of the example environment 100. Generally, through the GUI 190, server 103 users are provided with an efficient and user-friendly presentation of data provided by or communicated within the example environment 100. For example, the GUI 190 may be associated with client application 184 (e.g., a web browser) and used to view, navigate, and/or configure matrix menus, navigation lists, and associated content served by server 103. In some implementations, the client application 184 may be used to access various portions of the server 103. In some instances, the client application 184 may be an agent or client-side version of the application 127 or other suitable component of the server 103. The GUI 190 may present the information of the client application 184 for viewing and interaction. In some implementations, the matrix menu module 130, as well as other modules and configurators, can interact with users using the GUI 190. For example, the matrix menu module 130 can display a matrix menu along with other application windows for user interaction in the GUI 190.

As used in this disclosure, each client 175 is intended to encompass a personal computer, touch screen terminal, workstation, network computer, kiosk, wireless data port, smart phone, personal data assistant (PDA), one or more processors within these or other devices, or any other suitable processing device. For example, each client 175 may include a computer that includes an input device, such as a keypad, touch screen, mouse, or other device that can accept user information, and an output device that conveys information associated with the operation of one or more client applications 184, and/or the client 175 itself, including digital data, visual information, or the GUI 190. Both the input and output device may include fixed or removable storage media such as a magnetic storage media, CD-ROM, or other suitable media, to both receive input from and provide output to users of client 175 through the display, namely, the GUI 190. As previously stated, the client's processor 181, interface 178, and memory 187 may be similar to or different from those described in connection with the other components illustrated in FIG. 1, although alternative implementations of one or more of these components may be used, as well as implementations where additional components may also be included.

FIG. 1 depicts a client-server environment, but could also represent a cloud-computing network. Various other implementations of the illustrated environment 100 can be provided to allow for increased flexibility in the underlying system, including multiple application systems 103 performing or executing one or more additional or alternative instances of the application 127 for one or more different platforms, as well as multiple instances of the application 127 and its related functionality. In those instances, the different application systems 103 may communicate with each other using a cloud-based network or through the connections provided by network 148. Generally, the server 103 may be communicably coupled with the network 148 that facilitates wireless or wireline communications between the components of the environment 100 (i.e., between the server 103 and one or more clients 175), as well as with any other local or remote computer, such as additional clients, servers, or other devices communicably coupled to the network 148, including those not illustrated in FIG. 1. In the illustrated environment, the network 148 is depicted as a single network, but may be included in more than one network without departing from the scope of this disclosure, so long as at least a portion of the network 148 may facilitate communications between senders and recipients. In some instances, one or more of the components associated with the server 103 may be included within the network 148 as one or more cloud-based services or operations.

The network 148 may be all or a portion of an enterprise or secured network, while in another instance, at least a portion of the network 148 may represent a connection to the Internet. In the illustrated example, at least a portion of the network 148 includes a portion of a cellular or mobile data network or other network capable of relaying SMS messages. In some instances, a portion of the network 148 may be a virtual private network (VPN). Further, all or a portion of the network 148 can include either a wireline or wireless link. Example wireless links may include 802.11/b/g/n, 802.20, WIMAX, and/or any other appropriate wireless link. In other words, the network 148 encompasses any internal or external network, networks, sub-network, or combination thereof operable to facilitate communications between various computing components inside and outside the illustrated environment 100. The network 148 may communicate with, for example, Internet Protocol (IP) packets, Frame Relay frames, Asynchronous Transfer Mode (ATM) cells, voice, video, data, and other suitable information between network addresses. The network 148 may also include one or more local area networks (LANs), radio access networks (RANs), metropolitan area networks (MANs), wide area networks (WANs), all or a portion of the Internet, and/or any other communication system or systems at one or more locations.

FIGS. 2A and 2B illustrate example matrix menus. Turning first to FIG. 2A, an example application interface 200 is illustrated. The application interface 200 can be used as the GUI 190 of FIG. 1. The application interface 200 can include a matrix menu 210, a tab ribbon 220, and a main window 230. In this example, the matrix menu 210 includes a three by three array of navigation items 212. The navigation items 212 are generically represented using squares; but they can be icons, pictograms, texts, animations, and other contents. The tab ribbon 220 includes multiple tabs for multi-tasking using different pages or sub-windows in the main window 230. When a user launches an application or opens a file, the application or file can be displayed in the unoccupied portion of the main window 230.

FIG. 2B illustrates other possible configurations of matrix menus 240. For example, the matrix menus may have an unevenly distributed rows and columns, as shown in the matrix menus 251 and 253. Similarly, matrix menus may take any orientation, regular or irregular, as shown in the matrix menus 255, 257, and 259. Matrix menus may have an increased number of navigation items customizable to users, such as shown in the matrix menus 257, 259, and 260. In some implementations, matrix menus may take a non-intrusive form, such as a single row or column, or a multiplication of such, as shown in the matrix menus 263 and 265. The examples shown in FIG. 2B are only a few possibilities in configuring the matrix menu. Other configurations are possible, for example, the matrix menu may appear circular, highly divided, forming complicated visual effects, animated, and in other appearances. The number of navigation items in the matrix menus is not limited, and depending on required application, can form efficient access for users to bring out a related navigation list.

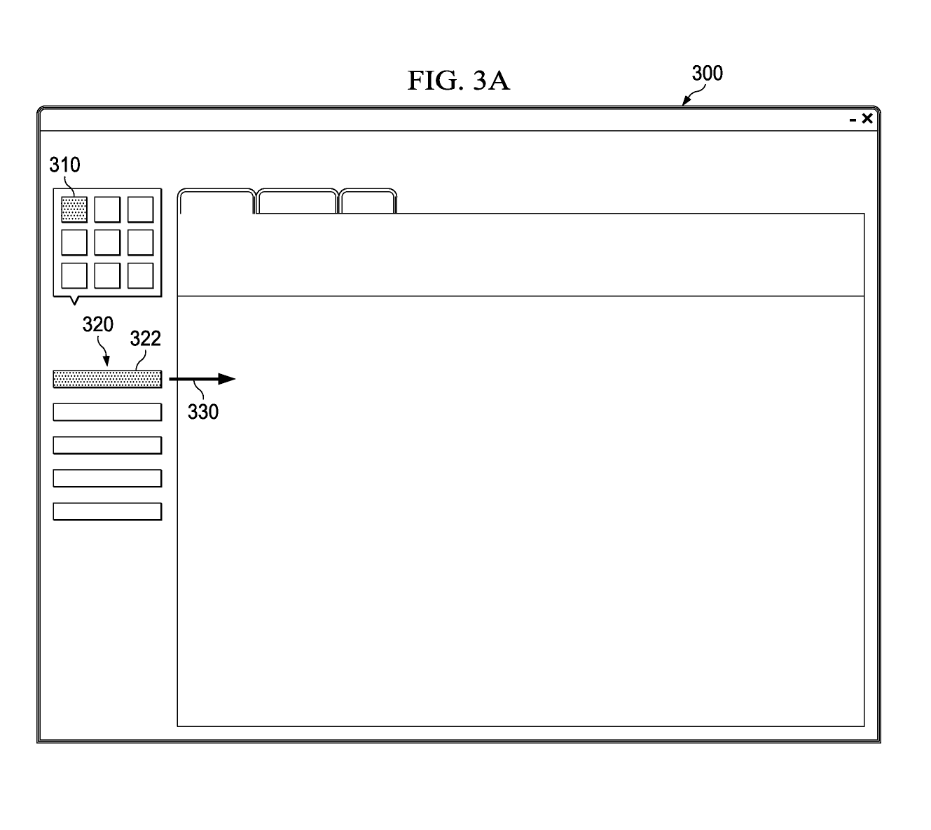

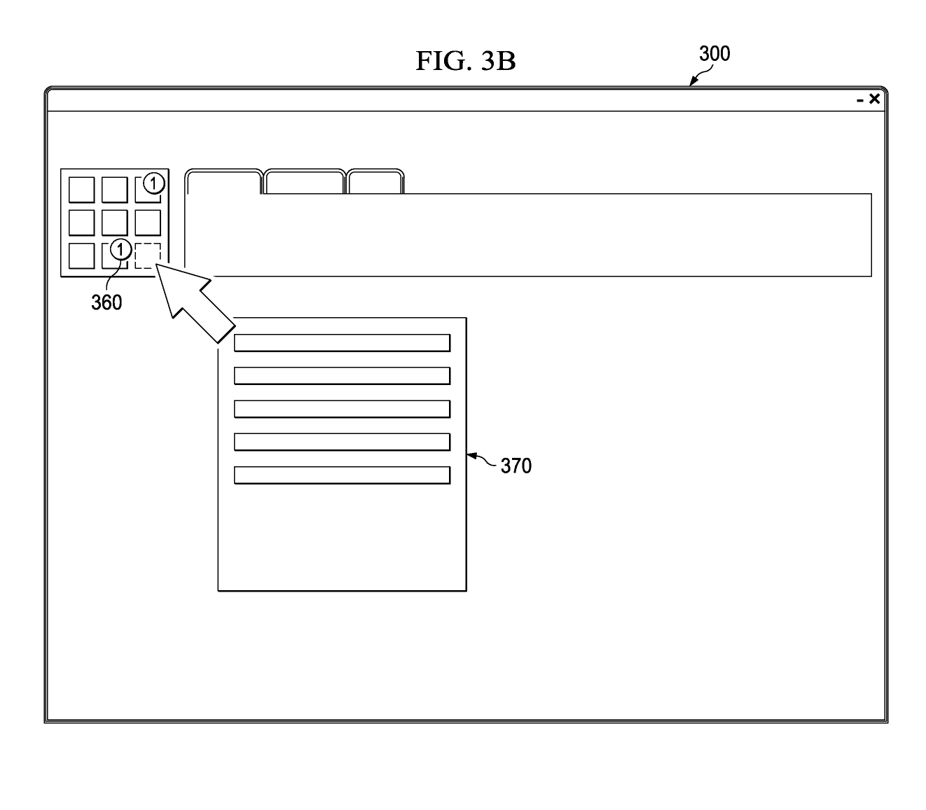

FIGS. 3A and 3B illustrate example functions of matrix menus. Turning first to FIG. 3A, an application interface 300 is shown when a navigation item 310 is selected in the matrix menu. The selection of navigation item 310 generates an expanded navigation list 320. The navigation list 320 includes multiple entries or items for user selection. For example, entry 322 in the navigation list 320 can be selected to launch an application 330. In some implementations, the navigation items in the matrix menu may be directly linked to the application 330. The application 330 can include a web application, a local application, a data file with an application, and other contents. In FIG. 3B, other features of the application interface 300 are shown. For example, notifications 360 can be displayed at the navigation items in the matrix menu. The notifications 360 can inform users about any incoming communications, warnings, messages, updates, and other contents. For ease of locating the application related to the notification 360, the notifications 360 may also populate to any related specific items on the navigation list when users select the navigation items in the matrix menu. Users may edit settings to the navigation list by bringing out a definition window 370, in which the users can define specific applications, their priorities, display orders, and other features to the navigation list related to a particular navigation item in the matrix menu.

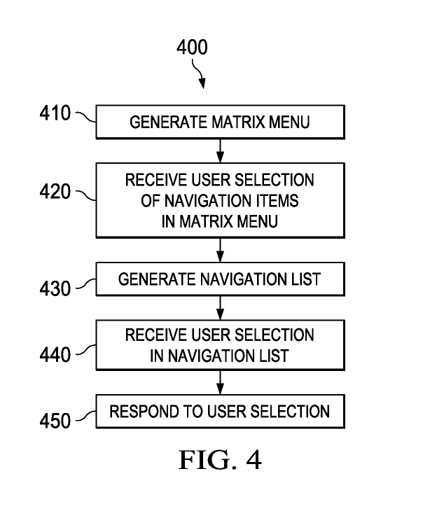

FIG. 4 illustrates an example method 400 for generating matrix menus. The example method 400 can be applied to the environment 100 of FIG. 1. At 410, a matrix menu is generated following an initiation event. The initiation event can be generated by and correspond to starting an application or system environment, for example, starting an operating system, application software, a web application, or other applications. The generated matrix menu displays an array of navigation items to users with which to interact. Each navigation item can be associated with a navigation list in which users can select particular applications and/or files to launch or open. The matrix menu can be configured to uniquely identify the application or system environment. For example, the matrix menu can present a particular overall visual impression to users about the application or system environment.

At 420, a user selection of one of the navigation items in the matrix menu is received. The user selection may be made using a cursor controlled using a pointing device, such as a mouse, a track ball, a laser pointer, a signature tracking system (e.g., a camera system using visible or infrared light), or other type of pointing device. In some implementations, the user selection may be made using a touchscreen, such as a tablet computer surface with pressure sensitivity, a multi-touch screen using capacitive or electric sensing, or other type of trackpad or touchscreen. At 430, in response to the selection of one of the navigation items in the matrix menu, a navigation list is generated. The navigation list can be defined by users. For example, users may configure certain files or applications to be included in the navigation list, and may define the order, priorities, hierarchy, and other properties related to the files or applications.

At 440, a user selection of one of the items in the navigation list is received. The user selection may be similar to the user selection described above in relation to the matrix menu. At 450, the selection of one of the items in the navigation list results in a response. The response may be, for example, the display of an application, a file, or other computational resources, in the GUI. In some implementations, the application can be a local or web-based application. In some implementations, the file can include data files that can be viewed directly or viewed using a specific application, which may be launched prior to or as a response to opening the file.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, and/or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-program product comprising computer-readable instructions embodied on tangible non-transitory media and operable when executed to:
generate an array of a plurality of navigation items arranged into a plurality of columns and a plurality of rows;
generate, in response to a selection of one of the plurality of navigation items, a navigation list operable to launch at least one application associated with the navigation list; and
execute, in response to a selection of one of the at least one application associated with the navigation list, the one of the at least one application.

2. The computer-program product of claim 1, wherein the at least one application associated with the navigation list is defined by a user.

3. The computer-program product of claim 1, wherein the at least one application associated with the navigation list is defined by an installation application.

4. The computer-program product of claim 1, wherein the array of navigation items includes one menu navigation column and a plurality of menu navigation rows.

5. The computer-program product of claim 1, wherein the array of navigation items further include a number of navigation layers.

6. The computer-program product of claim 1, wherein the array of navigation items includes a plurality of menu navigation columns and a plurality of menu navigation rows.

7. The computer-program product of claim 1, wherein each navigation items is capable of displaying a graphical notification.

8. The computer-program product of claim 1, wherein the at least one application is an executable file, a software program, a data file, a business application, or a web application.

9. The computer-program product of claim 8, wherein the at least one application is associated with at least one of the array of navigation items.

10. The computer-program product of claim 1, wherein the array of navigation items include non-text graphical icons.

11. The computer-program product of claim 1, wherein the array of navigation items include a plurality of matrices.

12. A computer-implemented method comprising:
generating an array of a plurality of navigation items arranged into a plurality of columns and a plurality of rows;
generating, in response to a selection of one of the plurality of navigation items, a navigation list operable to launch at least one application associated with the navigation list; and
executing, in response to a selection of one of the at least one application associated with the navigation list, the one of the at least one application.

13. The computer-implemented method of claim 12, wherein the at least one application associated with the navigation list is defined by a user.

14. The computer-implemented method of claim 12, wherein the at least one application associated with the navigation list is defined by an installation application.

15. The computer-implemented method of claim 12, wherein the array of navigation items includes one menu navigation column and a plurality of menu navigation rows.

16. The computer-implemented method of claim 12, wherein each navigation items is capable of displaying a graphical notification.

17. A system of one or more computers configured to perform operations comprising:
generating an array of a plurality of navigation items arranged into a plurality of columns and a plurality of rows;
generating, in response to a selection of one of the plurality of navigation items, a navigation list operable to launch at least one application associated with the navigation list; and
executing, in response to a selection of one of the at least one application associated with the navigation list, the one of the at least one application.

18. The system of claim 17, wherein the at least one application associated with the navigation list is defined by a user.

19. The system of claim 17, wherein the at least one application associated with the navigation list is defined by an installation application.

20. The system of claim 17, wherein each navigation items is capable of displaying a graphical notification.
